(19) United States
(12) Patent Application Publication
(10) Pub. No.: US 2014/0070664 A1
(43) Pub. Date: Mar. 13, 2014

(54) VIBRATION POWER GENERATOR

(71) Applicant: PANASONIC CORPORATION, Osaka (JP)

(72) Inventors: Takehiko Yamakawa, Osaka (JP); Hiroshi Nakatsuka, Osaka (JP); Keiji Onishi, Osaka (JP)

(21) Appl. No.: 14/114,604

(22) PCT Filed: Feb. 27, 2013
(86) PCT No.: PCT/JP2013/001185

§ 371 Date: Oct. 29, 2013

(30) Foreign Application Priority Data
Mar. 26, 2012 (JP) 2012-069109

(51) Int. Cl. H02N 1/08

(52) U.S. Cl. CPC H02N 1/08
USPC 310/300

(57) ABSTRACT

There is provided a vibration power generator for converting vibration energy into electric power. The vibration power generator includes a fixed substrate, and a vibrator capable of vibrating with respect to the fixed substrate. Fixed electrode pieces are disposed on the fixed substrate, and electret electrode pieces opposed to the fixed electrode pieces are disposed on the vibrator. The vibration power generator is adapted to generate electricity, through changes in capacitances between the fixed electrode pieces and the electret electrode pieces, due to the vibration of the vibrator. The electret electrode pieces have opposite end portions in the vibration direction which have a higher average electric-charge density per unit area than that of middle portions, in the vibration direction, of the electret electrode pieces.

### TECHNICAL FIELD

The present invention relates to vibration power generators for converting vibration energy into electric power.

### BACKGROUND ART

In recent years, attention has focused on environmental power generations for extracting electric power from energy existing widely in environments and for utilizing the extracted electric power in low-electric-power electronic apparatuses, such as solar power generations, thermoelectric power generations, and power generations utilizing electromagnetic inductions through magnets and coils. Among them, there have been known electrostatic-induction type vibration power generators adapted to extract electric power using vibration energy of human bodies, vehicles, machines, and the like. Such electrostatic-induction type vibration power generators have a vibrator within the device, wherein the vibrator is provided with electrodes and fixed electrode pieces opposed to the electrodes. On any of the electrodes and the fixed electrode pieces, there is disposed a film called an electret, which semi-permanently carries electric charges. Further, induced electric charges are changed using capacitance changes in these two types of electrodes, to cause an electric current to flow, thereby generating a voltage applied to a load to enable extraction of electric power.

FIG. 16 is a cross-sectional view of a conventional vibration power generator when electret electrode pieces and fixed electrode pieces are opposed to each other. FIG. 17 is a cross-sectional view of the conventional vibration power generator when guard electrode pieces and the fixed electrode pieces are opposed to each other. As illustrated in FIGS. 16 and 17, an insulation film 602 is provided on a fixed substrate 601, and a plurality of fixed electrode pieces 603 and a plurality of first guard electrode pieces 604 are alternately disposed on the insulation film 602. Spacers 605 are disposed on the fixed substrate 601, and a vibrator 607 is disposed above the fixed electrode pieces 603 and the first guard electrode pieces 604 on the fixed substrate 601 with a space therebetween, with at least two springs 606 connected to the spacers 605, such that the vibrator 607 can move through vibrations with the springs. A plurality of electret electrode pieces 609 and a plurality of second guard electrode pieces 610 are alternately disposed on the vibrator 607, with an insulation film 608 interposed therebetween. Above the vibrator 607, the vibrator 607 is sealed by a lid substrate 611 on the spacers 605. Negative electric charges are injected to the electret electrode pieces 609. The vibrator 607 can slide and vibrate in the direction of the electret electrode pieces 609 and the second guard electrode pieces 610. Further, when the electret electrode pieces 609 are opposed to the fixed electrode pieces 603 as illustrated in FIG. 16, a largest amount of induced positive electric charges is induced in the fixed electrode pieces 603. When the second guard electrode pieces 610 are opposed to the fixed electrode pieces 603, as illustrated in FIG. 17, a smallest amount of induced positive electric charges are generated in the fixed electrode pieces 603. Further, due to such increase and decrease in electric charges, an induced electric current is excited, and the induced electric current is rectified by a rectification circuit 612, whereby a voltage applied to a load 613 is generated, to cause the vibration power generator to generate electricity (refer to Patent Document 1).

In this case, negative electric charges are injected to the electret electrode pieces 609. This is performed by providing, from above, negative electric charges generated by corona discharge, and the electric charges are uniformly distributed in the direction X in the electret electrode pieces 609.

### PRIOR ART DOCUMENT

### Patent Document

Patent Document 1: JP 2011-040412 A

### SUMMARY OF THE INVENTION

### Problems to be Solved by the Invention

However, the aforementioned conventional structure is not capable of providing a sufficient amount of induced electric charges generated when the electret electrode pieces 609 and the fixed electrode pieces 603 are opposed to each other. This results in reduction of the induced electric current, thereby reducing the amount of electric power generated by the vibration power generator.

Therefore, it is an object of the present invention to provide a vibration power generator capable of generating an increased amount of induced electric charges for generating an increased amount of electric power.

### Solutions to the Problems

Provided is a vibration power generator for converting vibration energy into electric power, including: a fixed substrate; and a vibrator capable of vibrating with respect to the fixed substrate, wherein a fixed electrode piece is disposed on the fixed substrate, an electret electrode piece opposed to the fixed electrode piece is disposed on the vibrator, the vibration power generator is adapted to generate electricity, through a change in capacitance between the fixed electrode piece and the electret electrode piece, due to the vibration of the vibrator, and the electret electrode piece has opposite end portions in a vibration direction which have a higher average electric-charge density per unit area than that of a middle portion, in the vibration direction, of the electret electrode piece.

### Effects of the Invention

According to the present invention, it is possible to increase the amount of induced electric charges generated when the electret electrode pieces and the fixed electrode pieces are opposed to each other, which results in an increase of the amount of electric power generated by the vibration power generator.

### BRIEF DESCRIPTION OF THE DRAWINGS

FIG. 1 is a cross-sectional view of a vibration power generator according to a first embodiment of the present invention, when electret electrode pieces and fixed electrode pieces are opposed to each other.

FIG. 2 is a cross-sectional view of the vibration power generator according to the first embodiment of the present invention, when guard electrode pieces and the fixed electrode pieces are opposed to each other.

FIG. 3 is an enlarged view of electrode piece portions in the vibration power generator according to the first embodiment of the present invention.

FIG. 4 is a plan view of a fixed substrate in the vibration power generator according to the first embodiment of the present invention.

FIG. 5 is a plan view of a vibrator in the vibration power generator.

FIG. 6 is a view of an imaged electric-charge density when the average density of electric charges injected to the end portions and the middle portion of an electret electrode piece are made constant, in the vibration power generator according to the first embodiment of the present invention.

FIG. 7 is a view of an imaged electric-charge density when the average density of electric charges injected to the end portions of an electret electrode piece is smaller than the average density of electric charges injected to the middle portion thereof, in the vibration power generator according to the first embodiment of the present invention.

FIG. 8 is a view of an imaged electric-charge density when the average density of electric charges injected to the end portions of an electret electrode piece is larger than the average density of electric charges injected to the middle portion thereof, in the vibration power generator according to the first embodiment of the present invention.

FIG. 9 is a graph illustrating the amount of induced electric charges, with respect to the ratio between the average electric-charge density of the end portions and the average electric-charge density of the middle portion in FIGS. 6 to 8.

FIG. 10 is a graph illustrating the amount of induced electric charges, in cases of varying the allocation of the widths of the end portions and the width of the middle portion.

FIG. 11 is a cross-sectional view of a vibration power generator according to a second embodiment of the present invention, where a vibrator is provided with electret electrode pieces having recesses and protrusions.

FIG. 12 is an enlarged cross-sectional view of the electret electrode pieces and fixed electrode pieces, in the vibration power generator according to the second embodiment of the present invention.

FIG. 13 is a cross-sectional view of a vibration power generator according to a third embodiment of the present invention, where a vibrator is provided with electret electrode pieces formed of an oxide film covered with a nitride film.

FIG. 14 is an enlarged cross-sectional view of the electret electrode pieces and fixed electrode pieces, in the vibration power generator according to the third embodiment of the present invention.

FIG. 15 is an enlarged cross-sectional view of the electret electrode pieces and the fixed electrode pieces, illustrating a modification example of the third embodiment of the present invention.

FIG. 16 is a cross-sectional view of a conventional vibration power generator when electret electrode pieces and fixed electrode pieces are opposed to each other.

FIG. 17 is a cross-sectional view of the conventional vibration power generator when guard electrode pieces and the fixed electrode pieces are opposed to each other.

### EMBODIMENTS OF THE INVENTION

Hereinafter, embodiments of the present invention will be described with reference to the drawings.

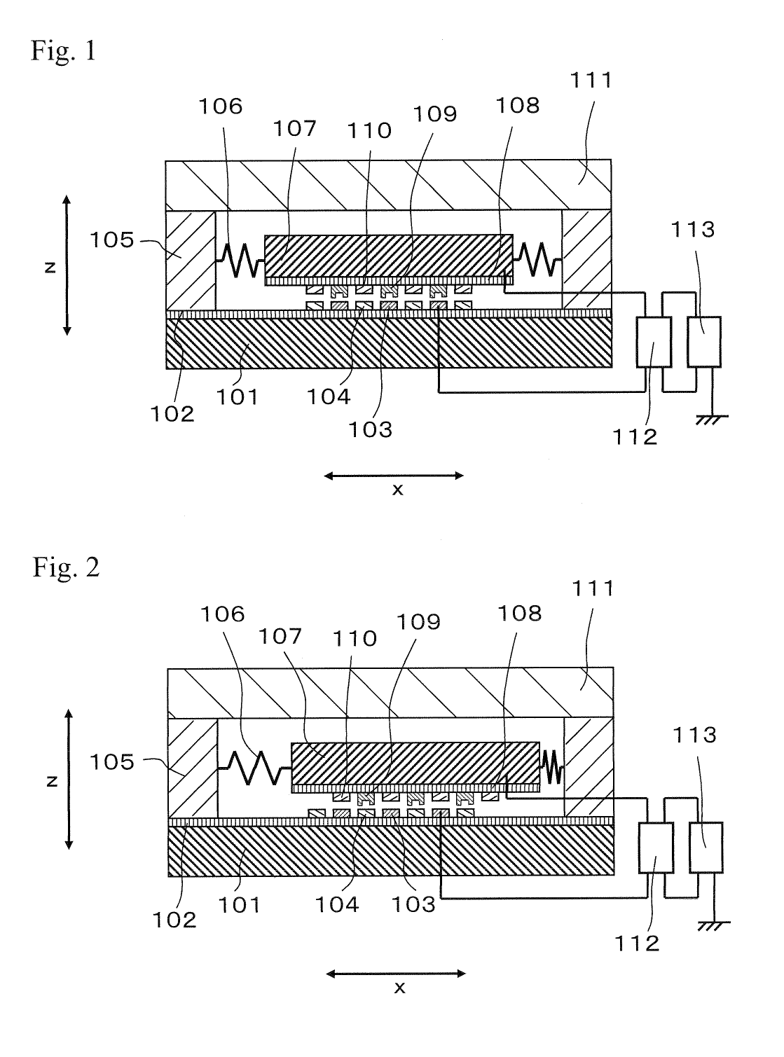

FIG. 1 is a cross-sectional view of a vibration power generator according to a first embodiment of the present invention, when electret electrode pieces and fixed electrode pieces are opposed to each other. FIG. 2 is a cross-sectional view of the vibration power generator according to the first embodiment of the present invention when guard electrode pieces and the fixed electrode pieces are opposed to each other.

As illustrated in FIGS. 1 and 2, an insulation film 102 formed of an oxide film is provided on a fixed substrate 101 made of silicon or glass, and a plurality of fixed electrode pieces 103 and a plurality of guard electrode pieces 104, which are made of poly-silicon or the like, are alternately disposed on the insulation film 102. Further, on the insulation film 102, spacers 105 made of silicon, glass, or a metal material are provided. A vibrator 107 made of silicon or glass is connected to the spacers 105 with at least two springs 106, and is disposed above the fixed electrode pieces 103 and the first guard electrode pieces 104 on the fixed substrate 101 with a space therebetween. With the springs 106, the vibrator 107 can vibrate in the direction X. The vibrator 107 is provided with an insulation film 108, so as to be opposed to the insulation film 102. Further, on the insulation film 108, a plurality of electret electrode pieces 109 formed of an oxide film or a nitride film, and a plurality of second guard electrode pieces 110 made of poly-silicon or the like are alternately disposed, so as to be opposed to the fixed electrode pieces 103 and the first guard electrode pieces 104. In this case, the direction in which the electret electrode pieces 109 and the second guard electrode pieces 110 are opposed to the fixed electrode pieces 103 and the first guard electrode pieces 104 is indicated as an opposing direction (a direction Z), and this opposing direction (the direction Z) is orthogonal to a vibration direction (a direction X). On the spacers 105, a lid substrate 111 made of silicon or glass is provided. The vibrator 107 is hermetically sealed by the fixed substrate 101, the fixed spacers 105, and the lid substrate 111.

Negative electric charges are injected to the electret electrode pieces 109. The vibrator 107 slides and vibrates in the direction of the electret electrode pieces 109 and the second guard electrode pieces 110. When the electret electrode pieces 109 are opposed to the fixed electrode pieces 103 as illustrated in FIG. 1, a largest amount of induced positive electric charges is induced in the fixed electrode pieces 103. When the second guard electrode pieces 110 are opposed to the fixed electrode pieces 103 as illustrated in FIG. 2, a smallest amount of induced positive electric charges is induced in the fixed electrode pieces 103. Due to such increase and decrease in induced electric charges, an induced electric current is generated. The generated induced electric current is rectified by a rectification circuit 112, and then outputted as a voltage through a load 113, thereby causing the vibration power generator to generate electricity.

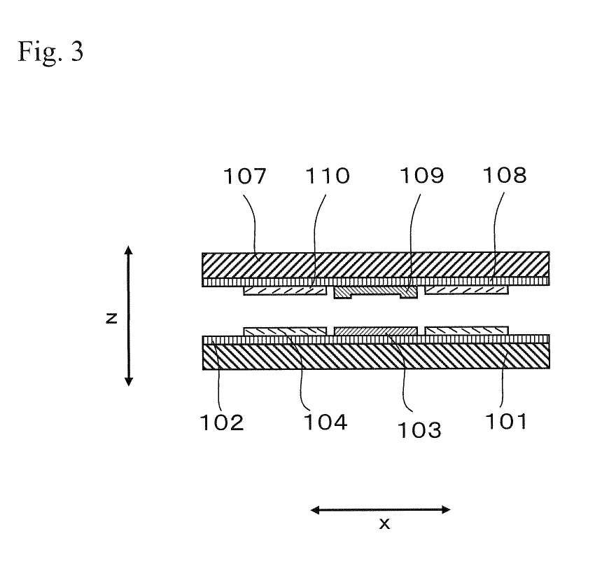

FIG. 3 is an enlarged cross-sectional view of the fixed electrode pieces 103 and the guard electrode pieces 104 on the first fixed electrode piece 101, and the electret electrode pieces 109 and the second guard electrode pieces 110 on the vibrator 107. The electret electrode pieces 109 are formed such that their end portions in the vibration direction (hereinafter, referred to as “end portions”) have a length in the opposing direction (hereinafter, referred to as “thickness”) which is larger than the thickness of their middle portions in the vibration direction (hereinafter, referred to as “middle portions”). Negative electric charges are injected to the electret electrode pieces 109, and this is performed by providing, from above, negative electric charges generated by corona discharge. Further, the average electric-charge density of injected electric charges, which is calculated as an amount of electric charges per unit area, is increased in proportion to the thickness of the electret electrode pieces 109. As a result, the end portions have a higher average electric-charge density than that of the middle portions.

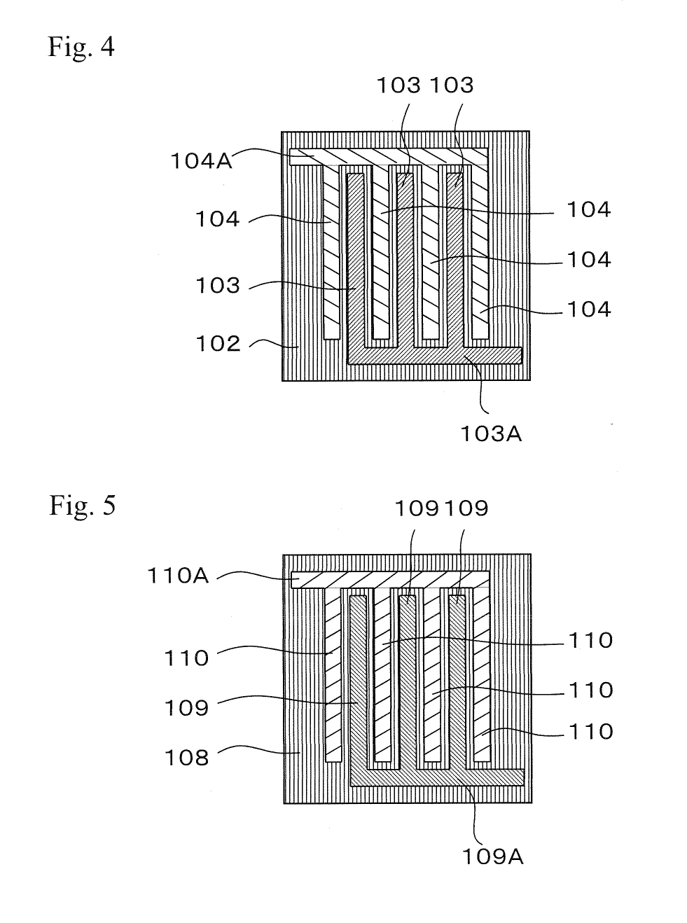

FIG. 4 is a plan view of the fixed substrate 101 in the vibration power generator according to the first embodiment of the present invention. FIG. 5 is a plan view of the vibrator 107 in the vibration power generator according to the embodiment of the present invention. As illustrated in FIG. 4, the fixed electrode pieces 103 on the insulation film 102 on the fixed substrate 101 form a fixed electrode body 103A having a continuous pattern shape, and the fixed electrode body 103A is connected to the rectification circuit 112 through a wiring electrode. Further, the first guard electrode pieces 104 form a first guard electrode body 104A having a continuous pattern shape, and the first guard electrode body 104A can be set to a predetermined electric potential through a wiring electrode and is usually grounded.

As illustrated in FIG. 5, the second guard electrode pieces 110 on the insulation film 108 on the vibrator 107 form a second guard electrode body 110A having a continuous pattern shape, and the second guard electrode body 110A can be set to a predetermined electric potential through a wiring electrode and is usually grounded. Although the electret electrode pieces 109 have a continuous pattern shape, they can be split from each other rather than being continuous.

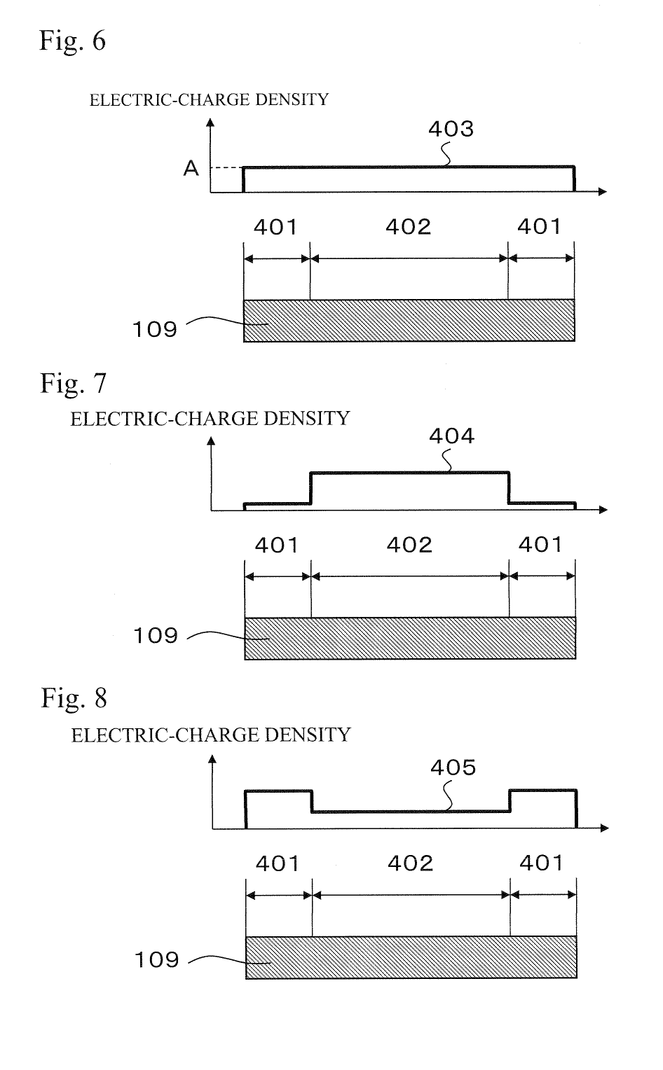

FIG. 6 is a view of an imaged electric-charge density when the average density of electric charges injected to the end portions and the middle portion of an electret electrode piece are made constant, in the vibration power generator according to the first embodiment of the present invention. FIG. 7 is a view of an imaged electric-charge density when the average density of electric charges injected to the end portions of an electret electrode piece is smaller than the average density of electric charges injected to the middle portion thereof. FIG. 8 is a view of an imaged electric-charge density when the average density of electric charges injected to the end portions of an electret electrode piece is larger than the average density of electric charges injected to the middle portion thereof. Referring to FIGS. 6 to 8, assuming that the length of the electret electrode piece 109 in the vibration direction (hereinafter, referred to as “width”) is 1, the width of the respective end portions 401 is 0.2 from the opposite end edges of the electret electrode piece 109 in the vibration direction. Further, the width of the middle portion 402 is 0.6, which is obtained by subtracting the width of the opposite end portions 401, which is 0.4, from the entire width of the electret electrode piece, which is 1.

In FIGS. 6 to 8, the total amount Q of electric charges injected to the electret electrode piece 109 is made constant. Further, in FIG. 6, the average electric-charge density of the end portions 401 and the average electric-charge density of the middle portion 402 have the same value A. Accordingly, electric charges of 0.4 Q in total are injected to the end portions 401 in the both ends, and electric charges of 0.6 Q are injected to the middle portion 402.

In FIG. 7, the average electric-charge density of the end portions 401 is A/4, while the average electric-charge density of the middle portion 402 is 3A/2. In this case, since the total amount of electric charges injected to the electret electrode piece 109 is Q, electric charges of 0.1 Q in total are injected to the end portions 401 in the both ends, and electric charges of 0.9 Q are injected to the middle portion 402.

In FIG. 8, the average electric-charge density of the end portions 401 is 4A/3, while the average electric-charge density of the middle portion 402 is 7A/9. In this case, since the total amount of electric charges injected to the electret electrode piece 109 is Q, electric charges of 8Q/15 in total are injected to the end portions 401 in the both ends, and electric charges of 7Q/15 are injected to the middle portion 402.

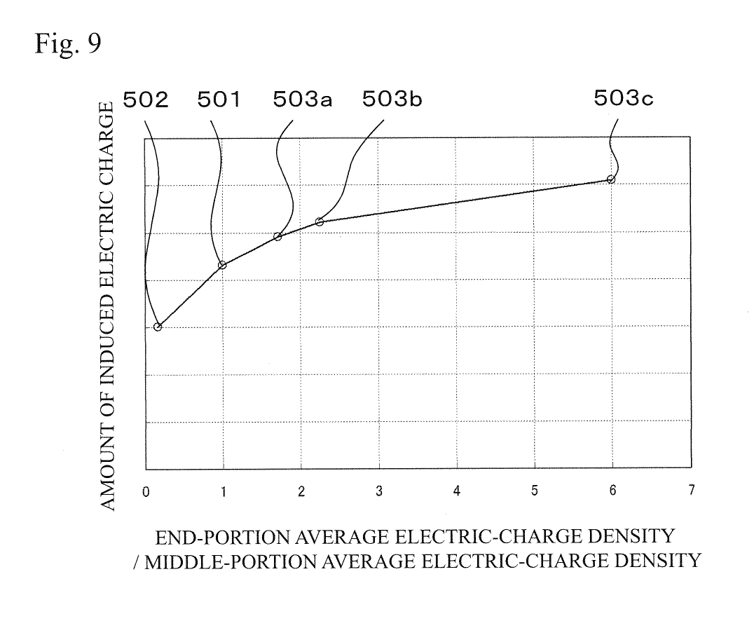

FIG. 9 is a graph illustrating the amount of induced electric charges, with respect to the ratio between the average electric-charge density of the end portions 401 and the average electric-charge density of the middle portion 402 in FIGS. 6 to 8. The horizontal axis in FIG. 9 indicates the ratio between the average electric-charge density of the end portions 401 and the average electric-charge density of the middle portion 402, while the vertical axis in FIG. 9 indicates the amount of induced electric charges. The amount of induced electric charges is defined as the difference between a largest amount of induced positive electric charges generated in the fixed electrode pieces 103 when the electret electrode pieces 109 and the fixed electrode pieces 103 are opposed to each other, and a smallest amount of induced positive electric charges generated in the fixed electrode pieces 103 when the second guard electrode pieces 110 and the fixed electrode pieces 103 are opposed to each other.

In FIG. 6, since the average electric-charge densities in the end portions 401 and the middle portion 402 are both A, the value obtained by dividing the average electric-charge density of the end portions by the average electric-charge density of the middle portion (hereinafter, referred to as “the average electric-charge density ratio”) is 1. In FIG. 9, “501” represents the amount of induced electric charges in the state of FIG. 6. In FIG. 7, the average electric-charge density of the end portions 401 is A/4, while the average electric-charge density of the middle portion 402 is 3A/2. Thus, the average electric-charge density ratio is 1/6. In FIG. 9, “502” represents the amount of induced electric charges in the state of FIG. 7. In FIG. 8, the average electric-charge density of the end portions 401 is 4A/3, while the average electric-charge density of the middle portion 402 is 7A/9. Thus, the average electric-charge density ratio is 12/7. In FIG. 9, “503a” represents the amount of induced electric charges in the state of FIG. 8.

Further, in FIG. 9, “503b” represents the amount of induced electric charges when the electric-charge density of the end portions 401 is 3A/2 and the electric-charge density of the middle portion 402 is 2A/3. Further, in FIG. 9, “503c” represents the amount of induced electric charges when the electric-charge density of the end portions 401 is 2A and the electric-charge density of the middle portion 402 is A/3.

As can be clearly seen from FIG. 9, by increasing the average electric-charge density ratio, that is, by increasing the average electric-charge density of the end portions 401 with respect to that of the middle portions 402, in the electret electrode pieces 109, it is possible to increase the amount of induced electric charges, i.e., the amount of power generation. This is for the following reason. That is, if the average electric-charge density of the end portions 401 is made larger than the average electric-charge density of the middle portions 402, this causes electric lines of forces in the end portions 401 to influence electric lines of forces in the middle portions 402, which generates a larger amount of induced electric charges in the fixed electrode pieces 103 opposed thereto. On the other hand, if the average electric-charge density of the end portions 401 is made smaller than the average electric-charge density of the middle portions 402, electric lines of forces in the end portions 401 are spread outwardly, and thus exert less influences on electric lines of forces in the middle portions 402, thereby inhibiting generation of induced electric charges in the fixed electrodes 103.

The vibration power generator having the above structure is capable of exerting the following effects.

(1) The end portions 401 in the electret electrode pieces 109 have a higher average electric-charge density per unit area than that of the middle portions 402 in the electret electrode pieces 109. Thus, it is possible to increase the amount of induced electric charges generated when the electret electrode pieces 109 and the fixed electrode pieces 103 are opposed to each other. This results in an increase in the amount of power generation in the vibration power generator.

(2) The plurality of fixed electrode pieces 103 are provided so as to be arranged in the vibration direction of the vibrator 107 (the direction X) and, similarly, the plurality of electret electrode pieces 109 are provided so as to be arranged in the vibration direction of the vibrator 107 (the direction X). Thus, it is possible to increase the amount of power generation in the vibration power generation, by increasing the number of the electret electrode pieces 109.

(3) The thickness of the end portions 401 of the electret electrode pieces 109 is made larger than the thickness of the middle portions 402 thereof. Thus, it is possible to easily make an average electric-charge density of the end portions 401 of the electret electrode pieces 109 higher than the average electric-charge density of the middle portions thereof.

(4) The fixed substrate 101, the spacers 105, and the lid substrate 111 form the closed space which is hermetically sealed so as to prevent intrusion of external air thereinto. Thus, it is possible to prevent electric charges from being separated from the electret electrode pieces 109. Note that the sealing structure is not limited to the sealing structure in the above embodiment.

### Other Embodiments

In the first embodiment, the thickness of the end portions 401 is made larger than the thickness of the middle portions 402, as means for making the average electric-charge density of the end portions 401 higher than the average electric-charge density of the middle portions 402. However, in the present invention, the average electric-charge density of the end portions 401 only needs to be higher than the average electric-charge density of the middle portions 402. For example, it is possible to obtain the same effects, by forming an electric-charge outflow suppression film on the end portions 401. It is also possible to make the thickness of the end portions 401 larger than the thickness of the middle portions 402, and further, form an electric-charge outflow suppression film on the end portions 401, to thereby make the average electric-charge density of the end portions 401 much higher than the average electric-charge density of the middle portions 402.

In the first embodiment, the number of the electret electrode pieces 109 is three, but, in general, the vibration power generation is provided with a larger number of electret electrode pieces 109. By decreasing the width of the electret electrode pieces 109 to a width which prevents reduction of electric charges injected therein, and then increasing the number of the electret electrode pieces 109, it is possible to increase the frequency of the output voltage extracted through the load 113 with respect to the vibration frequency, thereby increasing the amount of power generation.

In the first embodiment, the springs 106 are constituted by coil springs. However, the present invention is not limited to the coil springs, and members capable of spring operations such as materials with high repulsion elasticity may be used.

In the first embodiment, the first guard electrode pieces 104 and the second guard electrode pieces 110 are provided, and they are provided to increase the rate of the change in capacitance between the fixed electrode pieces 103 and the electret electrode pieces 109. It is also possible to eliminate the first guard electrode pieces 104 and the second guard electrode pieces 110, and it is possible to provide other members.

Regarding the materials forming the fixed substrate 101, the insulation film 102, the fixed electrode pieces 103, the first guard electrode pieces 104, the spacers 105, the vibrator 107, the insulation film 108, the electret electrode pieces 109, the second guard electrode pieces 110, and the lid substrate 111, the aforementioned materials are merely examples. In other words, the fixed substrate 101 and the lid substrate 111 may be formed of resin substrates or metal blocks. The fixed electrode pieces 103, the first guard electrode pieces 104, and the second guard electrode pieces 110 may be formed of conductive materials such as aluminum or copper. The electret electrode pieces 109 may be formed of organic-based electret materials.

In the first embodiment, the rectification circuit 112 and the vibrator 107 are connected to each other. However, it is also possible to provide electrodes with a size substantially equal to that of the electret electrode pieces 109 at lower portions of the electret electrode pieces 109, and connect the rectification circuit 112 to these electrodes.

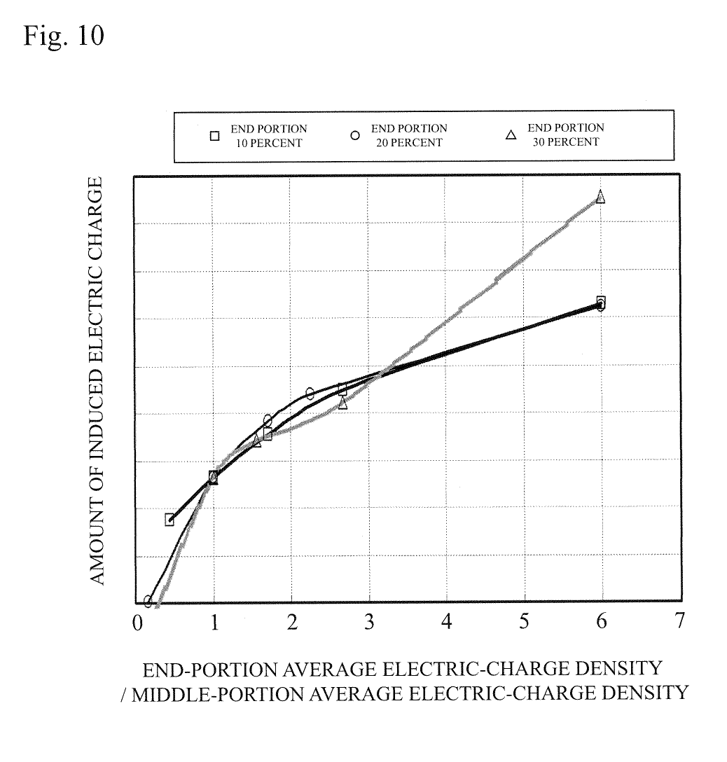

In the first embodiment, the widths of the opposite end portions 401 is each made to be 20 percent of the entire width of each electret electrode piece 109, and the width of the middle portion 402 is made to be 60 percent of the entire width of the electret electrode piece 109. However, the allocation of the widths of the end portions 401 and the width of the middle portion 402 is not limited thereto. FIG. 10 is a graph illustrating the amount of induced electric charges, in cases of varying the allocation of the widths of the end portions 401 and the width of the middle portion 402. As illustrated in FIG. 10, when the widths of the opposite end portions 401 is each made to be 10 to 30 percent of the entire width, it can be seen that the amount of induced electric charges tends to increase by increasing the average electric-charge density ratio. In other words, the widths of the opposite end portions 401 may each be 10 to 30 percent of the entire width, while the width of the middle portion 402 may be 40 to 80 percent of the entire width.

In the first embodiment, the fixed electrode pieces and the electret electrode pieces are opposed to each other in the vertical direction, and the electret electrode pieces 109 are positioned above the fixed electrode pieces 103. However, in the present invention, the fixed electrode pieces 103 and the electret electrode pieces 109 only need to be disposed so as to be opposed to each other, and the present invention is not limited to the aforementioned positional relationship. For example, the fixed electrode pieces and the electret electrode pieces may be opposed to each other in the vertical direction, and the electret electrode pieces may be positioned below the fixed electrode pieces. Also, the fixed electret pieces and the electret electrode pieces may be positioned so as to be opposed to each other in the horizontal direction.

The lead wire to the rectification circuit 112 and the lead wire for grounding the vibrator 107 are illustrated as images of connected lines in FIGS. 1 and 2. However, it goes without saying that, in actual, they are connected through wiring electrodes and substrate-penetrated electrodes disposed on a substrate.

In the first embodiment, negative electric charges are injected to the electret electrode pieces 109, but it is also possible to inject positive electric charges thereto. When positive electric charges are injected thereto, the induced electric charges have a different polarity and electric currents flow in the opposite direction. However, it goes without saying that the same effects as those of the first embodiment can be obtained.

### Second Embodiment

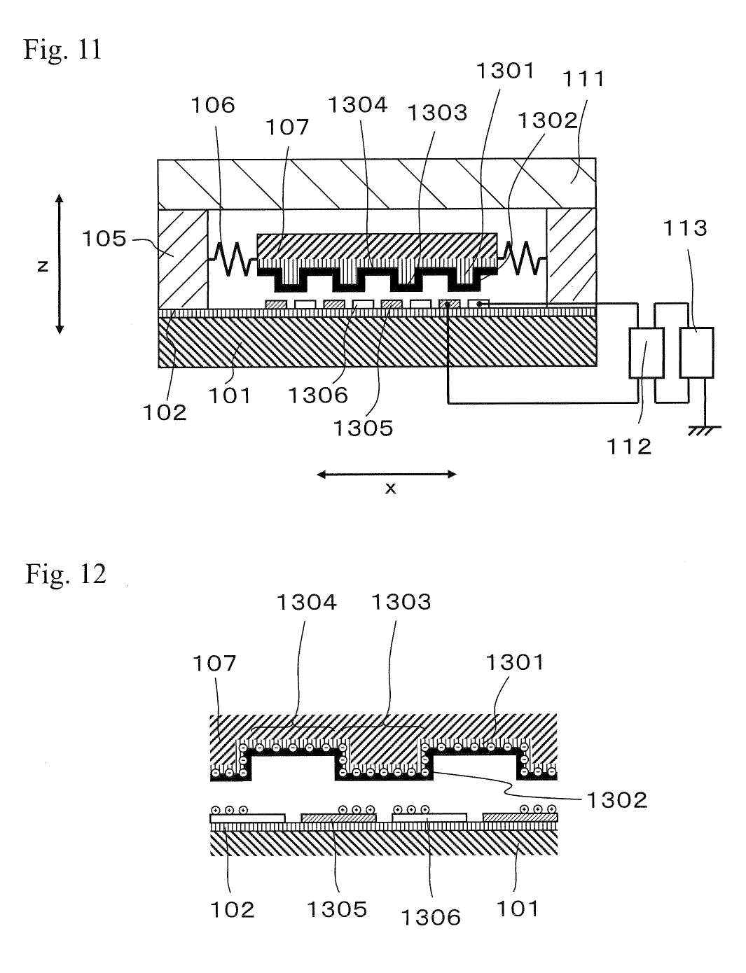

FIG. 11 is a cross-sectional view of a vibration power generator according to a second embodiment of the present invention, where a vibrator is provided with electret electrode pieces having recesses and protrusions. FIG. 12 is an enlarged cross-sectional view of the electret electrode pieces and fixed electrode pieces. Hereinafter, the same components as those of the first embodiment will be denoted by the same reference characters and will not be described.

As illustrated in FIGS. 11 and 12, the vibrator 107 made of silicon or glass is deeply carved into strip shapes by an etching technique and the like, an oxide film 1301 is formed thereon, and a nitride film 1302 is formed thereon, to thereby form electret electrode piece protrusions 1303 and electret electrode piece recesses 1304. On a fixed substrate 101 opposed to the electret electrode pieces, first fixed electrode pieces 1305 and second fixed electrode pieces 1306 are disposed. The respective electrodes are connected to a rectification circuit 112, and the output of the vibration power generator is extracted through a load 113.

As illustrated in FIG. 12, negative electric charges are injected to the electret electrode pieces, electric charges are usually held in the boundary surface between the oxide film 1301 and the nitride film 1302, and electric charges are also held in the electret electrode piece protrusions 1303 and in the electret electrode piece recesses 1304. When the first fixed electrode pieces 1305 and the second fixed electrode pieces 1306 are opposed to the electret electrode piece protrusions 1303, the distance therebetween is smaller, and capacitance therebetween is larger, which generates induced positive electric charges corresponding to negative electric charges injected to the electret electrode piece protrusions 1303. On the other hand, when the first fixed electrode pieces 1305 and the second fixed electrode pieces 1306 are opposed to the electret electrode piece recesses 1304, the distance therebetween is larger, and capacitance therebetween is smaller, which generates a smaller amount of induced positive electric charges or no induced positive electric charge. In other words, the electret electrode piece recesses 1304 operate similarly to the second guard electrode pieces 110 according to the first embodiment. Due to such increase and decrease in induced electric charges, an electric current flows therethrough, thereby causing the vibration power generator to operate as a power generator.

In this case, at the boundaries between the electret electrode piece protrusions 1303 and the electret electrode piece recesses 1304, there exist the end portions where the vibrator 107 is carved, and there also exists the boundary surface between the oxide film 1301 and the nitride film 1302, where negative electric charges are also held therein. That is, due to influences thereof, the end portions of the electret electrode piece protrusions 1303 have a higher average electric-charge density of electric charges than that of the middle portions thereof. As described above, similarly to the first embodiment, the vibration power generator is capable of generating an increased amount of electricity, with the electret electrode pieces having a higher average electric-charge density at their end portions.

Further, with the present structure, the electret electrode pieces form a continuous electrode having less discontinuity, which reduces paths for outflows of negative electric charges injected therein, whereby electric charges are held with higher stability.

Further, two terminals connected to the rectification circuit can be constituted by the first fixed electrode pieces 1305 and the second fixed electrode pieces 1306, rather than by the fixed electrode pieces 103 and the vibrator 107 as in the first embodiment. This facilitates connections of the terminals, which reduces influences of stray capacitances, thereby increasing the power generation output.

In the second embodiment, the electret electrode pieces are disposed in both the protrusions and recesses, but the electret electrode pieces may be disposed at least in the protrusions.

### Third Embodiment

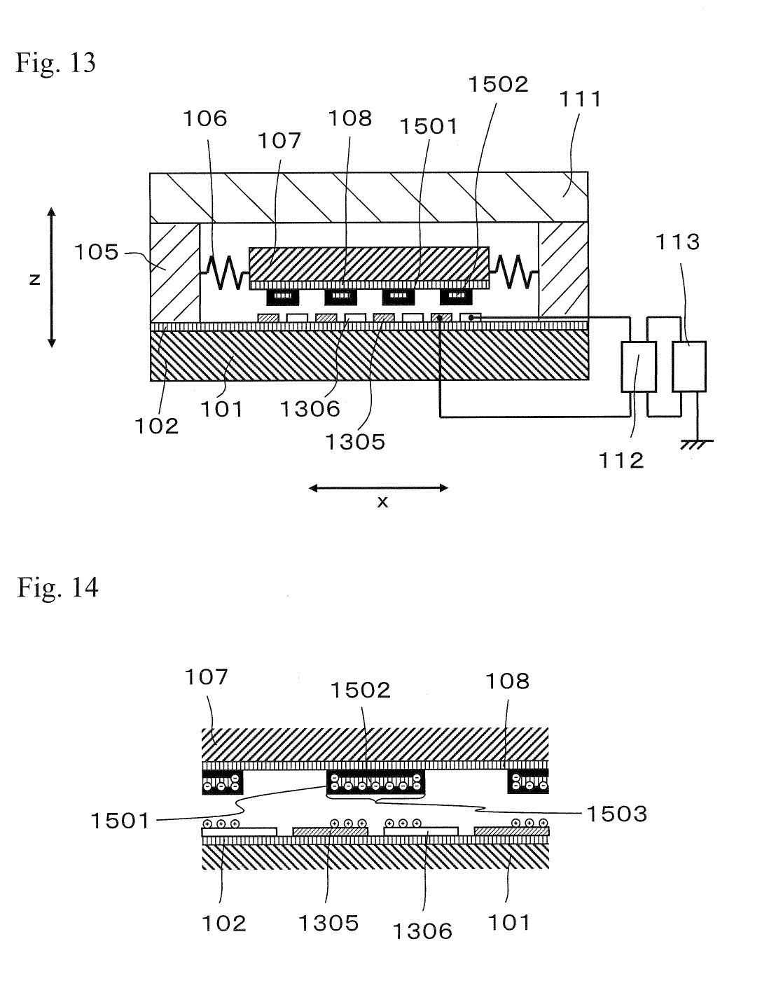

FIG. 13 is a cross-sectional view of a vibration power generator according to a third embodiment of the present invention, where a vibrator is provided with electret electrode pieces formed of an oxide film covered by a nitride film. FIG. 14 is an enlarged cross-sectional view of the electret electrode pieces and fixed electrode pieces. Hereinafter, the same components as those of the first or second embodiment will be denoted by the same reference characters and will not be described.

As illustrated in FIGS. 13 and 14, an oxide film 108 is formed on the vibrator 107 which is made of silicon or glass, an oxide film 1502 covered by a nitride film 1501 is formed thereon, to thereby form electret electrode pieces 1503. On a fixed substrate 101 opposed to the electret electrode pieces 1503, first fixed electrode pieces 1305 and second fixed electrode pieces 1306 are disposed. The respective electrodes are connected to a rectification circuit 112, and the output of the vibration power generator is extracted through a load 113.

As illustrated in FIG. 14, negative electric charges are injected to the electret electrode pieces 1503, and electric charges are usually held in the boundary surface between the nitride film 1501 and the oxide film 1502. When the first fixed electrode pieces 1305 and the second fixed electrode pieces 1306 are opposed to the electret electrode pieces 1503, the distance therebetween is smaller, and capacitance therebetween is larger, which generates induced positive electric charges corresponding to negative electric charges injected to the electret electrode pieces 1503. On the other hand, when the first fixed electrode pieces 1305 and the second fixed electrode pieces 1306 are opposed to portions having no electret electrode piece 1503, no induced electric charge is generated. In other words, the portions having no electret electrode piece 1503 operate similarly to the second guard electrode pieces 110 according to the first embodiment. Due to such increase and decrease in induced electric charges, an electric current flows therethrough, thereby causing the vibration power generator to operate as a power generator.

In this case, in the end portions of the electret electrode pieces 1503, the boundary surface between the nitride film 1501 and the oxide film 1502 exists not only in the flat surfaces parallel to the vibration direction but also in the thickness direction perpendicular to the vibration direction, and negative electric charges are also held therein. In other words, due to influences thereof, the end portions of the electret electrode pieces 1503 have a higher average electric-charge density of electric charges than that of the middle portions thereof. As described above, similarly to the first embodiment, the vibration power generator is capable of generating an increased amount of electricity, with the electret electrode pieces 1503 having a higher average electric-charge density at their end portions.

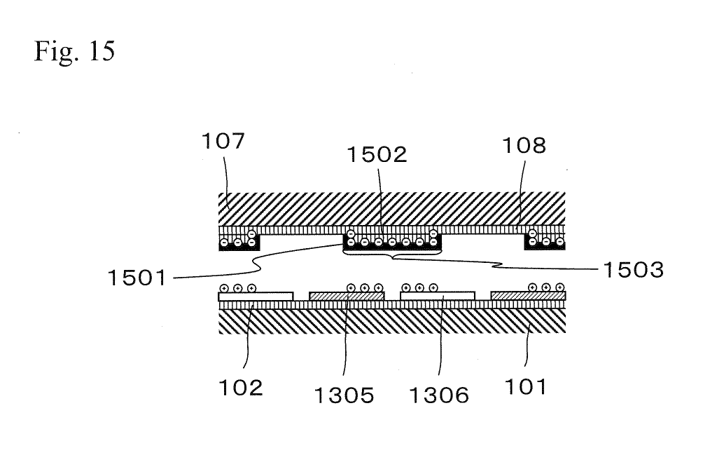

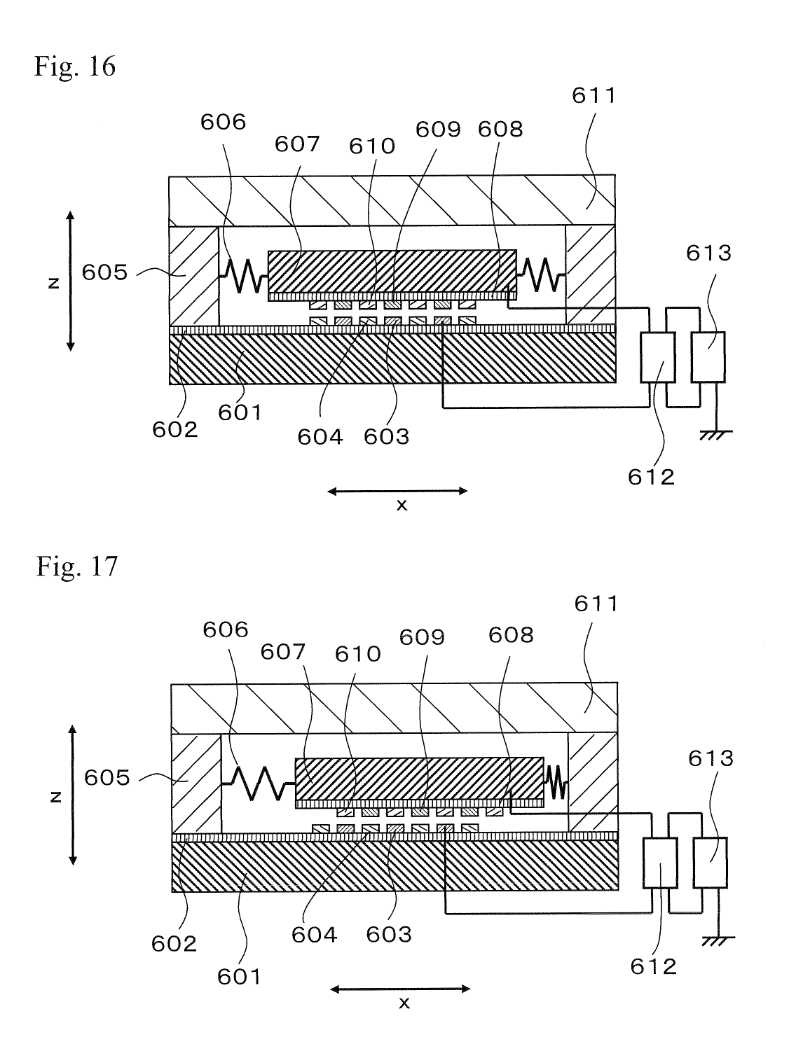

In the electret electrode pieces 1503, the entire periphery of the oxide film 1502 is coated by the nitride film 1501. However, even if the surface of the oxide film 1502 close to the insulation film 108 is not coated with the nitride film 1501, as illustrated in FIG. 15, it is possible to obtain the same effects if the boundary surface between the nitride film 1501 and the oxide film 1502 exists in the flat surfaces in the longitudinal direction (the surfaces close to the fixed electrode pieces 1305 and 1306) and in the vertical surfaces of the end portions.

In the second and third embodiments, the electret electrode pieces 1303 and 1503 are formed of the oxide film coated with the nitride film. However, also in the first embodiment, the electret electrode pieces 109 may be formed of an oxide film coated with a nitride film.

Further, in the second and third embodiments, an electric-charge outflow suppression film described in the first embodiment is preferably formed on the opposite end portions of the electret electrode pieces in the vibration direction.

Various modifications and changes can be made without departing from the spirit and the scope of the present invention described in the claims.

### INDUSTRIAL APPLICABILITY

The vibration power generator according to the present invention is applicable to various types of vibration energy in external environments.

### DESCRIPTION OF REFERENCE SIGNS

101: Fixed substrate
102: Insulation film
103: Fixed electrode piece
103A: Fixed electrode body
104: First guard electrode piece
104A: First guard electrode body
105: Spacer
106: Spring
107: Vibrator
108: Insulation film
109: Electret electrode piece
109A: Electret electrode body
110: Second guard electrode piece
110A: Second guard electrode body
111: Lid substrate
112: Rectification circuit
113: Load
401: End portion
402: Middle portion
403: Imaged electric-charge density when average density of electric charges injected to end portions and middle portion are constant
404: Imaged electric-charge density when average density of electric charges injected to end portions is smaller than average density of electric charges injected to middle portion
405: Imaged electric-charge density when average density of electric charges injected to end portions is larger than average density of electric charges injected to middle portion
501: Amount of induced electric charges when average electric-charge density ratio is 1
502: Amount of induced electric charges when average electric-charge density ratio is 1/6
503a: Amount of induced electric charges when average electric-charge density ratio is 12/7
503b: Amount of induced electric charges when average electric-charge density ratio is 9/4
503c: Amount of induced electric charges when average electric-charge density ratio is 6
601: Fixed substrate
602: Insulation film
603: Fixed electrode piece
604: First guard electrode piece
605: Spacer spring
606: Spring
607: Vibrator
608: Insulation film
609: Electret electrode piece
610: Second guard electrode piece
611: Lid substrate
612: Rectification circuit
613: Load

1. A vibration power generator for converting vibration energy into electric power, comprising:
a fixed substrate; and
a vibrator capable of vibrating with respect to the fixed substrate, wherein
a fixed electrode piece is disposed on the fixed substrate,
an electret electrode piece opposed to the fixed electrode piece is disposed on the vibrator,
the vibration power generator is adapted to generate electricity, through a change in capacitance between the fixed electrode piece and the electret electrode piece, due to the vibration of the vibrator, and
the electret electrode piece has opposite end portions in a vibration direction which have a higher average electric-charge density per unit area than that of a middle portion, in the vibration direction, of the electret electrode piece.

2. The vibration power generator according to claim 1, wherein
a plurality of the fixed electrode pieces are provided so as to be arranged in the vibration direction of the vibrator, and
a plurality of the electret electrode pieces are provided so as to be arranged in the vibration direction of the vibrator.

3. The vibration power generator according to claim 1, wherein
the opposite end portions, in the vibration direction, of the electret electrode piece have a thickness in an opposing direction which is larger than the thickness, in the opposing direction, of the middle portion, in the vibration direction, of the electret electrode piece.

4. The vibration power generator according to claim 1, wherein
the vibrator is provided with a strip-shaped recess, and an electric-charge holding film is formed to extend over a protrusion and a recess which are formed by the strip-shaped recess, and
the electret electrode piece is disposed at least on the protrusion.

5. The vibration power generator according to claim 1, wherein
the electret electrode piece is formed of an oxide film coated with a nitride film.

6. The vibration power generator according to claim 1, wherein
an electric-charge outflow suppression film is formed on the opposite end portions, in the vibration direction, of the electret electrode piece.
